(19) United States
(12) Patent Application Publication
(10) Pub. No.: US 2019/0371177 A1
(43) Pub. Date: Dec. 5, 2019

(54) PARKING SPACE GUIDANCE APPARATUS AND PARKING SPACE GUIDANCE METHOD

(71) Applicant: TOYOTA JIDOSHA KABUSHIKI KAISHA, Toyota-shi (JP)

(72) Inventors: Yoshiyuki KAGEURA, Sunto-gun (JP); Yoshihiro SAKAYANAGI, Mishima-shi (JP); Shuntaro SHINOHARA, Susono-shi (JP)

(73) Assignee: TOYOTA JIDOSHA KABUSHIKI KAISHA, Toyota-shi (JP)

(21) Appl. No.: 16/419,188

(22) Filed: May 22, 2019

(30) Foreign Application Priority Data
Jun. 5, 2018 (JP) 2018-107917

(51) Int. Cl. G08G 1/14; G06Q 20/10; G07B 15/02; G01C 21/36

(52) U.S. Cl. CPC G08G 1/148; G08G 1/143; G01C 21/3685; G07B 15/02; G06Q 20/10

(57) ABSTRACT

A parking space guidance apparatus configured so that when receiving from one terminal among a plurality of terminals a request signal seeking guidance to a parking space, it determines a request receiving terminal from which to request yielding of a parking space and sends the request receiving terminal a request signal requesting yielding of the parking space, when receiving from the request receiving terminal an accept signal indicating willingness of yielding the parking space, sends to the one terminal a request succeed signal including the position of the parking space occupied by the request receiving vehicle and, when receiving a movement completion signal indicating that parking at the parking space which the request receiving vehicle had been occupying has become possible or receiving a parking completion signal indicating parking of the request sending vehicle at that parking space, decreases the economic value held by the user of the one terminal and increases the economic value held by the user of the request receiving terminal.

### CROSS-REFERENCE TO RELATED APPLICATION

This application claims priority based on Japanese Patent Application No. 2018-107917 filed with the Japan Patent Office on Jun. 5, 2018, the entire contents of which are incorporated into the present specification by reference.

### FIELD

The present disclosure relates to a parking space guidance apparatus and parking space guidance method.

### BACKGROUND

Japanese Unexamined Patent Publication No. 2012-068939 discloses a parking lot guidance system communicating between a parking management apparatus installed at a parking lot and a vehicle to guide the vehicle to an empty parking space of the parking lot.

### SUMMARY

The degree of desire to park at an empty parking space differs among drivers of vehicles. For example, among drivers, there may be ones who desire to park their vehicles at parking spaces earlier than other vehicles even if paying an economic consideration. However, the above-mentioned conventional parking lot guidance system was one which guided vehicles to empty parking spaces on an equal basis, so could not guide specific drivers to empty parking spaces on a priority basis.

The present disclosure was made focusing on such a problem and has as its object to enable specific users (for example, drivers) to be guided to parking spaces on a priority basis.

To solve this problem, the parking space guidance apparatus according to one aspect of the present disclosure comprises a communication part able to communicate with a plurality of terminals associated with different vehicles, a storage part storing information expressing economic value held by users of a plurality of terminals or vehicles associated with the plurality of terminals and positions of parking spaces when the vehicles associated with the plurality of terminals park at parking spaces, and a control part performing processing for guidance to a parking space. The control part is configured so that when receiving from one terminal among the plurality of terminals a request signal seeking guidance to a parking space, it determines a request receiving terminal from which to request yielding of a parking space from among other terminals associated with parked vehicles in the plurality of terminals and sends the request receiving terminal a request signal requesting yielding of the parking space, when receiving from the request receiving terminal an accept signal indicating willingness of yielding the parking space, sends to the one terminal a request succeed signal including the position of the parking space occupied by the request receiving vehicle associated with the request receiving terminal, and, when receiving a movement completion signal indicating that parking at the parking space which the request receiving vehicle had been occupying has become possible or a parking completion signal indicating parking of the request sending vehicle associated with the one terminal at that parking space, decreases the economic value held by the user of the one terminal or the request sending vehicle and increases the economic value held by the user of the request receiving terminal or request receiving vehicle.

Further, the parking space guidance method according to one aspect of the present disclosure receives a request seeking guidance to a parking space from a request sending user desiring to use a parking space at which time it requests another user occupying a parking space to move from that parking space on the condition of being paid an economic consideration and, when that request is accepted, guides the request sending user to the parking space which had been occupied by the other user.

According to these aspects of the present disclosure, it is possible to guide a user of a specific vehicle or the user of a terminal associated with that vehicle to a parking space on a priority basis conditional on payment of an economic consideration.

### BRIEF DESCRIPTION OF DRAWINGS

FIG. 1 is a schematic view of the configuration of a parking space guidance system according to a first embodiment of the present disclosure.

FIG. 2 is a schematic view of the configuration of a server.

FIG. 3 is a schematic view of the configuration of a terminal.

FIG. 4 is a view showing one example of the state in the parking space guidance system when processing for guidance to a parking space is performed.

FIG. 5 is a view showing one example of a sequence of operations of processing for guidance to a parking space in a first embodiment of the present disclosure.

FIG. 6 is a flow chart for explaining processing relating to a server in processing for guidance to a parking space according to the first embodiment of the present disclosure.

FIG. 7 is a view showing one example of a sequence of operations of processing for guidance to a parking space according to a second embodiment of the present disclosure.

FIG. 8 is a flow chart for explaining processing relating to a server in processing for guidance to a parking space according to the second embodiment of the present disclosure.

### DESCRIPTION OF EMBODIMENTS

Below, referring to the drawings, embodiments of the present disclosure will be explained in detail. Note that, in the following explanation, similar component elements are assigned the same reference notations.

### First Embodiment

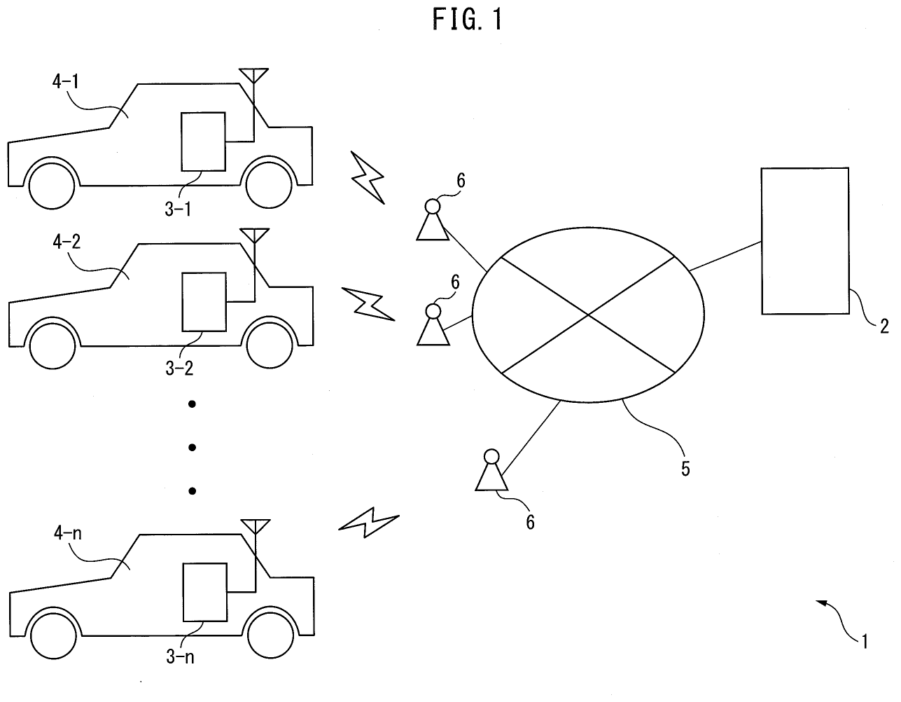

FIG. 1 is a schematic view of the configuration of a parking space guidance system 1 according to a first embodiment of the present disclosure.

The parking space guidance system 1 comprises a server 2 as one example of a parking space guidance apparatus and a plurality of terminals 3-1 to 3-n (“n” is an integer of 3 or more). The terminal 3-1 is associated with a vehicle 4-1. Similarly, the terminals 3-2 to 3-n are associated with the vehicles 4-2 to 4-n.

The server 2 is connected with a communication network 5 comprised of optical communication lines etc., through a gateway (not shown), etc. The terminals 3-1 to 3-n access wireless base stations 6 connected with the communication network 5 through gateway etc. and thereby are connected with the communication network 5 through the wireless base stations 6. That is, the server 2 and the plurality of terminals 3-1 to 3-n can communicate with each other through the communication network 5.

The terminals 3-1 to 3-n are, for example, mobile phones or tablet computers or other mobile terminals having wireless communication functions or are car mounted navigation systems. Note that, the terminals 3-1 to 3-n may all be equipment of the same type as each other or may all be equipment of different types from each other. For example, the terminal 3-1 may be a mobile phone while the terminal 3-2 may be a navigation system mounted in the vehicle 4-2 associated with the terminal 3-2.

The terminals 3-1 to 3-n generate parking signals including parked positions and the facts of being in parked states when the vehicles 4-1 to 4-n associated with the terminals 3-1 to 3-n are parked and send those parking signals to the server 2.

In generating the parking signals, the terminals 3-1 to 3-n, for example, can make the current positions of the terminals 3-1 to 3-n measured based on a received global positioning system (GPS) signal the parked positions of the vehicles 4-1 to 4-n.

Further, if the terminals 3-1 to 3-n are car-mounted navigation systems, for example, when the startup switches of the vehicles 4-1 to 4-n are turned to OFF and the navigation systems stop, it can be judged that the vehicles 4-1 to 4-n are in the parked states. On the other hand, if the terminals 3-1 to 3-n are devices different from car-mounted navigation systems, for example, it can be judged that the vehicles 4-1 to 4-n are in the parked states by using short distance wireless communications based on predetermined communication protocols for short distance wireless use such as Bluetooth® to detect when the startup switches of the vehicles 4-1 to 4-n are in the OFF states.

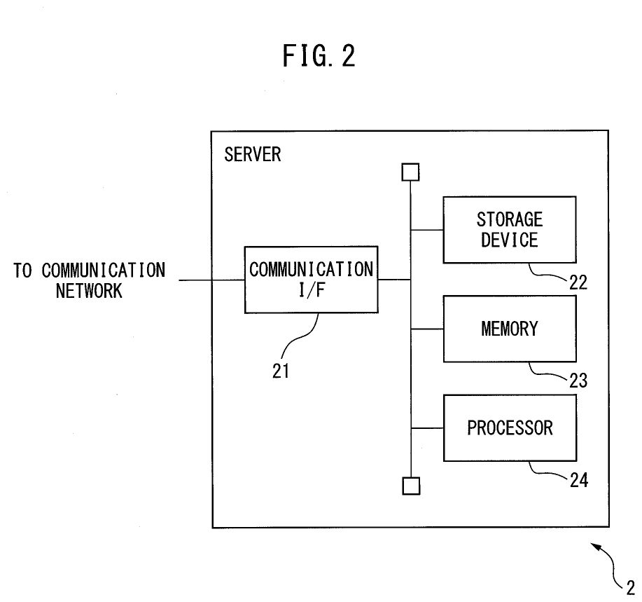

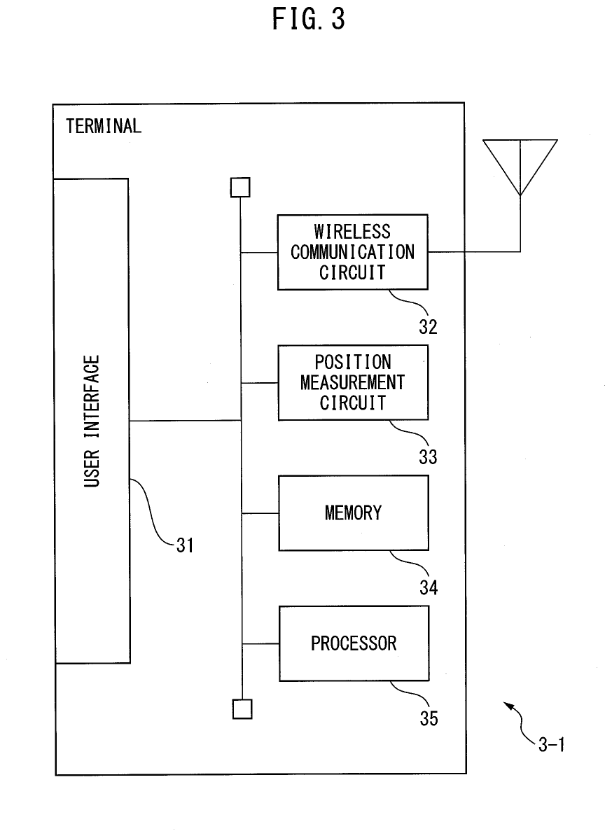

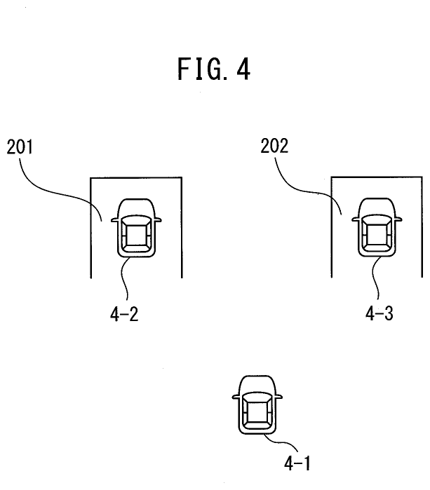

The parking space guidance system 1 according to the present embodiment performs processing for guidance to a parking space which, when receiving from a user trying to utilize a parking space a request seeking guidance to a parking space, requests a user occupying a parking space to move from that parking space conditional on payment of an economic consideration and thereby guides on a priority basis a specific user desiring to utilize a parking space to the parking space which the user requested to move from the parking space had been occupying. Below, referring to FIG. 2 and FIG. 3, the detailed configurations of the server 2 and the terminals 3-1 to 3-n will be explained, then details of the processing for guidance to a parking space will be explained while referring to FIG. 4 to FIG. 6.

FIG. 2 is a schematic view of the configuration of the server 2.

As shown in FIG. 2, the server 2 is comprised of a communication interface 21, storage device 22, memory 23, and processor 24. The communication interface 21, storage device 22, and memory 23 are connected with the processor 24 through signal lines. The server 2 may further comprise input devices of a keyboard and mouse and an output device of a display.

The communication interface 21 is one example of a communication part. It is comprised of an interface circuit for connecting the server 2 to a communication network 5 and is configured to be able to communicate with the terminals 3-1 to 3-n through the communication network 5.

The storage device 22 is one example of a storage part and for example comprises a hard disk drive or optical recording medium and an access device of the same.

The storage device 22 stores identification information of the terminals 3-1 to 3-n and identification information, current positions, and parking states of the vehicles 4-1 to 4-n associated with the terminals 3-1 to 3-n all linked together. The identification information of the terminals 3-1 to 3-n can, for example, be made MAC addresses. The identification information of the vehicles 4-1 to 4-n can, for example, be made license plate numbers of the vehicles 4-1 to 4-n.

Further, the storage device 22 stores names and user numbers of users of the terminals 3-1 to 3-n, point information showing economic value, etc. Further, the storage device 22 stores map information. Note that, in the present embodiment, the example is shown where point information expressing economic value is held by the users of the terminals 3-1 to 3-n, but the disclosure is not limited to this. The point information expressing economic value for example may also be held by the vehicles 4-1 to 4-n associated with the terminals 3-1 to 3-n.

The memory 23 is another example of a storage part and for example comprises a nonvolatile semiconductor memory and a volatile semiconductor memory. Further, the memory 23 stores various types of data generated during performance of processing for guidance to a parking space.

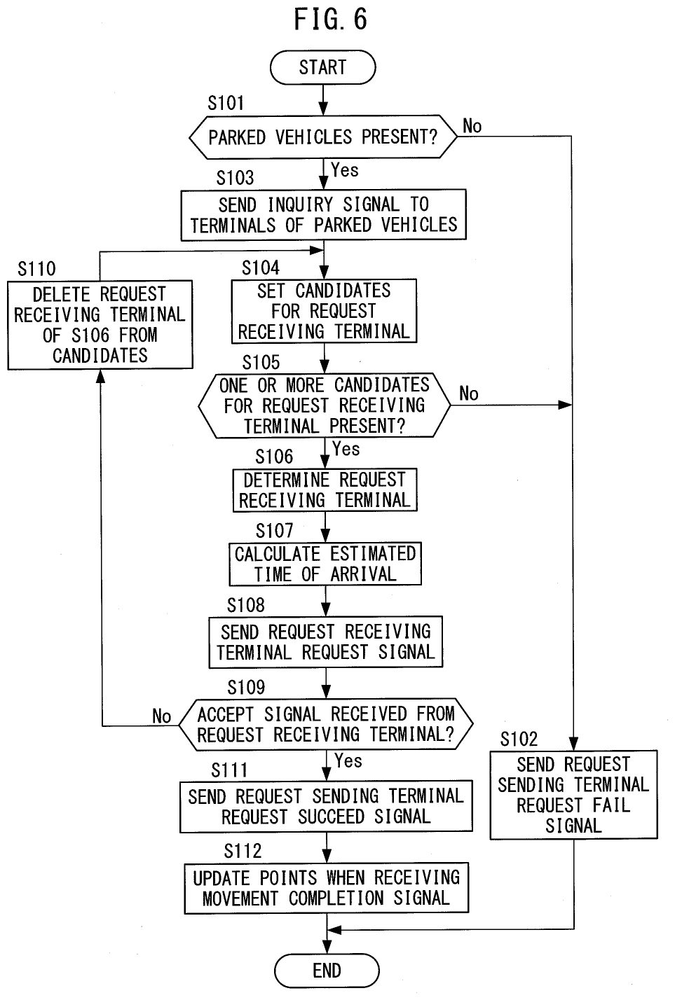

The processor 24 is one example of a control part and comprises one or more CPUs (central processing units) and their peripheral circuits. The processor 24 may further comprise other processing circuits such as logic processing units or numeric processing units. Further, the processor 24 performs processing relating to the server 2 in the processing for guidance to a parking space. The processing relating to the server 2 in the processing for guidance to a parking space will be explained later with reference to FIG. 6.

Next, referring to FIG. 3, details of the terminals 3-1 to 3-n will be explained. Note that, the terminals 3-1 to 3-n are configured the same in the constitutions relating to the processing for guidance to a parking space, so here, the configuration of the terminal 3-1 will be explained as representative of them.

FIG. 3 is a schematic view of the configuration of the terminal 3-1.

The terminal 3-1 comprises a user interface 31, wireless communication circuit 32, position measurement circuit 33, memory 34, and processor 35. The terminal 3-1 may further comprise a short distance wireless communication circuit (not shown) for wireless communication with car-mounted equipment.

The user interface 31, for example, is a touch panel display. The user interface 31 generates signals corresponding to the various types of operations relating to the processing for guidance to a parking space by the user (for example, startup of application relating to guidance to a parking space etc.) and outputs those signals to the processor 35. Further, the user interface 31 displays various types of information for display use received from the processor 35.

The wireless communication circuit 32, for example, comprises an antenna and a signal processing circuit performing various types of processing relating to wireless communication such as modulation and demodulation of the wireless signals. The wireless communication circuit 32 receives a wireless signal of a downlink from a wireless base station 6 or sends a wireless signal of an uplink to a wireless base station 6. That is, the wireless communication circuit 32 takes out from the wireless signal of a downlink received from a wireless base station 6 the signal sent from the server 2 to the terminal 3-1 and forwards it to the processor 35. Further, the wireless communication circuit 32 generates a wireless signal of an uplink including the signal received from the processor 35 and sent to the server 2 and sends this wireless signal.

The position measurement circuit 33 acquires information expressing the position of the terminal 3-1. The position measurement circuit 33, for example, comprises a receiver receiving a GPS signal and a processing circuit calculating the position of the terminal 3-1 from the GPS signal. The position measurement circuit 33 measures the position of the terminal 3-1 based on the GPS signal and notifies that position to the processor 35 each time it measures the position of the terminal 3-1.

The memory 34, for example, comprises a rewritable nonvolatile semiconductor memory and a rewritable volatile semiconductor memory. The memory 34 stores various types of application programs run by the processor 35 and various types of data. Further, the memory 34 stores various types of data relating to the performance of processing for guidance to a parking space.

The processor 35 comprises one or more CPUs and their peripheral circuits. The processor 35 may further comprise other processing circuits such as logic processing units and numeric processing units. The processor 35 performs processing relating to the terminal 3-1 in the processing for guidance to a parking space. For example, the processor 35 generates a signal for transmission to the server 2 in accordance with operation by the user and outputs the generated signal to the wireless communication circuit 32.

FIG. 4 is a view showing one example of the state in the parking space guidance system 1 when processing for guidance to a parking space is performed. In the example shown in FIG. 4, the driver of the vehicle 4-1 is looking for a parking space to park the vehicle 4-1. Further, at parking spaces 201 and 202 positioned around the destination of the vehicle 4-1, the vehicles 4-2 and 4-3 are parked.

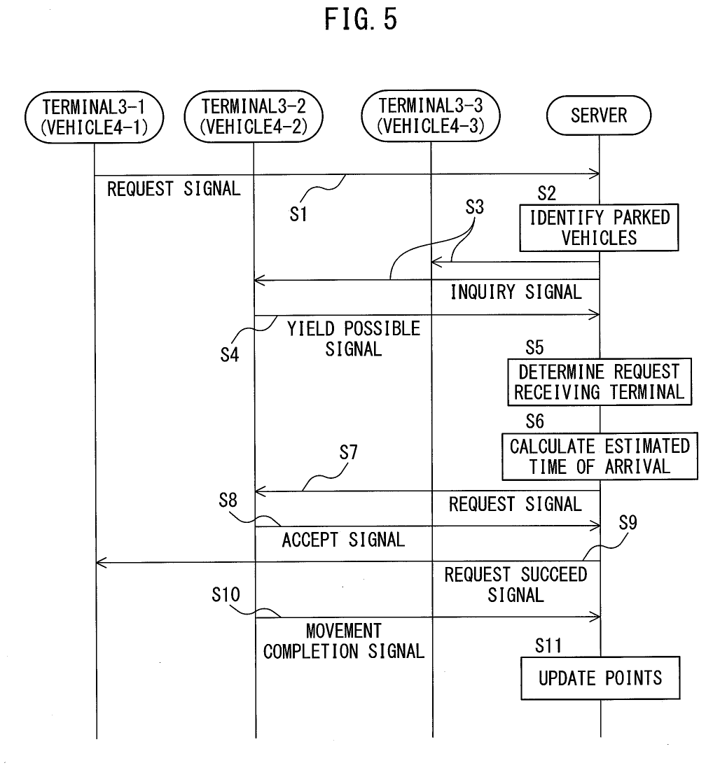

FIG. 5 is a view showing one example of a sequence of operations of processing for guidance to a parking space. It is a view showing the flow of processing for guidance to a parking space in the case where, in the state shown in FIG. 4, the driver of the vehicle 4-1, that is, the user of the terminal 3-1 associated with the vehicle 4-1, desires to be guided to a parking space and the driver of the vehicle 4-2, that is, the user of the terminal 3-2 associated with the vehicle 4-2, has indicated his willingness to yield the parking space.

Note that, in the following explanation, for convenience, in accordance with need, a terminal of a user desiring to be guided to a parking space will be referred to as a “request sending terminal” and the vehicle associated with that request sending terminal will be referred to as a “request sending vehicle”. Further, a terminal of a user requested to move from an occupied parking space, that is, to yield the parking space, will be referred to as a “request receiving terminal” and the vehicle associated with the request receiving terminal will be referred to as a “request receiving vehicle”. Therefore, in the state shown in FIG. 4, the terminal 3-1 becomes the request sending terminal while the terminal 3-2 becomes the request receiving terminal. Further, the vehicle 4-1 becomes the request sending vehicle while the vehicle 4-2 becomes the request receiving vehicle.

At step S1, if the user of the terminal 3-1 operates the terminal 3-1 to request guidance to a parking space, the terminal 3-1 generates a request signal and sends that request signal to the server 2. The request operation can, for example, be performed through a parking space guidance application running on the terminal 3-1.

The request signal generated by the terminal 3-1 includes identification information of the terminal 3-1 and the current position and destination of the vehicle 4-1 associated with the terminal 3-1.

In generating the request signal, the terminal 3-1 can, for example, make the current position of the terminal 3-1 measured based on the received global positioning system (GPS) signal the current position of the vehicle 4-1.

Further, if the terminal 3-1 is a navigation system mounted in the vehicle 4-1, the destination set in the navigation system can be made the destination of the vehicle 4-1.

On the other hand, if the terminal 3-1 is equipment different from a navigation system mounted in the vehicle 4-1, the terminal 3-1 can, for example, make the destination set in a navigation application running on the terminal 3-1 the destination of the vehicle 4-1. Further, the terminal 3-1 can, for example, make the destination acquired from the navigation system mounted in the vehicle 4-1 by Bluetooth® short distance wireless communications based on predetermined communication protocols for short distance wireless use the destination of the vehicle 4-1. Further, the terminal 3-1 may make the destination input by the user through a parking space guidance application running on the terminal 3-1 the destination of the vehicle 4-1.

At step S2, when receiving a request signal from the terminal 3-1, the server 2 identifies other vehicles parked at parking spaces in a predetermined range from the destination of the vehicle 4-1 included in the request signal (below, referred to as the “parked vehicles”).

For example, the server 2 can designate a range within a predetermined distance (for example, within 200 m) from the destination of the vehicle 4-1 as the predetermined range and specify as parked vehicles the vehicles parked at positions within that predetermined distance among the vehicles whose parked positions are stored. Further, the server 2 can designate a parking lot of the destination of the vehicle 4-1 as the predetermined range and specify as parked vehicles the vehicles parked in that parking lot among the vehicles whose parked positions are stored. In this case, the server 2 may refer to the map information which the server 2 stores to identify the range of the parking lot of the destination of the vehicle 4-1 and judge for each vehicle whose parked positions are stored whether the parked position of that vehicle is included in the identified range of the parking lot so as to identify the vehicles parked in the parking lot of the destination of the vehicle 4-1.

At step S3, the server 2 sends to the terminals associated with the identified parked vehicles (in this example, the vehicles 4-2 and 4-3) (in this example, the terminals 3-2 and 3-3) an inquiry signal inquiring if they can yield their parking spaces.

At step S4, if the terminals receiving the inquiry signal (in this example, the terminals 3-2 and 3-3) may be able to yield their parking spaces, they return to the server 2 yield possible signals including notifications to that effect and parked positions of the vehicles associated with the terminals. Note that, in this example, only the terminal 3-2 returns a yield possible signal to the server 2.

A terminal receiving an inquiry signal can return a yield possible signal to the server 2 if the ignition switch or other startup switch of the vehicle associated with the terminal is in the ON state and driving is possible or if the destination is being set in the navigation system of the vehicle associated with that terminal. Further, a terminal receiving an inquiry signal may also return a yield possible signal to the server 2 if the user of that terminal enters into that terminal a willingness to yield his own parking space.

At step S5, the server 2 determines, among the terminals returning yield possible signals, the request receiving terminal from which to request yielding of the parking space within a certain time frame (for example within 10 minutes) from sending the inquiry signal.

Specifically, if there is just one terminal returning a yield possible signal, the server 2 sets that terminal as the request receiving terminal. Further, if there are several terminals returning yield possible signals, the server 2 sets as the request receiving terminal the terminal associated with the vehicle parked at the position closest to the destination of the vehicle 4-1 based on the parked positions of the vehicles associated with the terminals included in the yield possible signals among the plurality of terminals. On the other hand, if there is not even one terminal returning a yield possible signal, the server 2 sends to the request sending terminal a request fail signal notifying the absence of any parking space which can be guided to.

In this example, the only terminal returning a yield possible signal is the terminal 3-2, so the server 2 sets the terminal 3-2 as the request receiving terminal.

At step S6, the server 2 calculates the estimated time of arrival of the vehicle 4-1 at the parked position of the vehicle 4-2 (below, referred to as the “estimated time of arrival”) based on the current position of the vehicle 4-1 (request sending vehicle) and the parked position of the vehicle 4-2 (request receiving vehicle) included in the yield possible signal returned from the terminal 3-2 (request receiving terminal).

At step S7, the server 2 sends the terminal 3-2 a request signal requesting the parking space be yielded before the estimated time of arrival.

At step S8, the user of the terminal 3-2 receiving the request signal inputs into his own terminal whether he may yield his own parking space. If at this time willingness to yield the parking space is input, the terminal 3-2 returns an accept signal to the server 2. On the other hand, if unwillingness to yield the parking space is input, the terminal 3-2 returns a decline signal to the server 2.

In this example, the user of the terminal 3-2 inputs willingness to yield his parking space, so the terminal 3-2 returns an accept signal to the server 2.

At step S9, if receiving an accept signal within a certain time frame from when sending the request signal (for example, within 10 minutes), the server 2 sends a request succeed signal including the parked position of the vehicle 4-2 (request receiving vehicle) to the terminal 3-1 (request sending terminal). On the other hand, if the server 2 receives a decline signal or if there is no reply from the terminal 3-2 within a certain time frame, the server 2 sends a request deny signal to the terminal 3-1, deletes the terminal 3-2 from the candidates of request receiving terminals, then returns to step S5 and again determines the request receiving terminal.

In this example, the server 2 receives from the terminal 3-2 an accept signal within a certain time frame from when sending the request signal, so sends a request succeed signal to the terminal 3-1.

At step S10, if the vehicle 4-2 associated with the terminal 3-2 (request receiving vehicle) moves from parking space, the terminal 3-2 (request receiving terminal) sends the server 2 a movement completion signal notifying completion of movement.

For example, the terminal 3-2 can judge that the vehicle 4-2 has moved from its parking space if the position of the vehicle 4-2 associated with the terminal 3-2 is a predetermined distance (for example, a distance greater than the parking space in the longitudinal direction, for example, 5 m to 10 m) or more from the position at the time of parking. The judgment of whether the vehicle 4-2 has moved from its parking space may, for example, be made using the current position of the terminal 3-2 measured based on the received GPS signal as the position of the vehicle 4-2. Further, in addition to such a method, if for example the vehicle 4-2 is provided with a camera, it is possible to judge that the vehicle 4-2 has moved from the parking space based on an image obtained by the camera.

At step S11, when receiving a movement completion signal, the server 2 updates the points (economic value) held by the user of the terminal 3-1 (request sending terminal) and the user of the terminal 3-2 (request receiving terminal). Specifically, the server 2 subtracts from the points held by the user of the terminal 3-1 the points corresponding to the total of the amount of consideration for getting a parking space yielded and a handling fee. Further, the server 2 adds to the points held by the user of the terminal 3-2 the amount of consideration for yielding the parking space.

At this time, the server 2 may notify the points after subtraction to the terminal 3-1 (request sending terminal). Further, the server 2 may notify the points after addition to the terminal 3-2 (request receiving terminal).

FIG. 6 is a flow chart for explaining processing relating to the server 2 in processing for guidance to a parking space. When the server 2 receives a request signal, the processor 24 performs processing relating to the server 2 in the processing for guidance to a parking space in accordance with the present routine.

At step S101, the processor 24 judges if there are parked vehicles parked at parking spaces within a predetermined range around the destination of the request sending vehicle based on the destination of the request sending vehicle included in the request signal and the current positions of the parked vehicles stored in the storage device 22. If there are no parked vehicles, the processor 24 proceeds to the processing of step S102. On the other hand, if there are parked vehicles, the processor 24 proceeds to the processing of step S103.

At step S102, the processor 24 sends a request fail signal notifying the fact that there is no parking space which can be guided to through the communication interface 21 and the communication network 5 to the request sending terminal.

At step S103, the processor 24 identifies the terminals associated with the parked vehicles based on the identification information of the parked vehicles and sends an inquiry signal inquiring whether they may yield their parking spaces through the communication interface 21 and the communication network 5 to the identified terminals.

At step S104, the processor 24 designates terminals which returned yield possible signals within a certain time frame from when sending the inquiry signal as candidates for the request receiving terminal from which to request yielding of the parking space.

At step S105, the processor 24 judges if there are one or more candidates for the request receiving terminal. If there are one or more candidates for the request receiving terminal, the processor 24 proceeds to the processing of step S106. On the other hand, if there is not even one candidate for the request receiving terminal, the processor 24 proceeds to the processing of step S102.

At step S106, the processor 24 determines the request receiving terminal from the candidates for the request receiving terminal. When there is only one candidate for the request receiving terminal, the processor 24 sets that one terminal listed as a candidate as the request receiving terminal. On the other hand, when there are a plurality of candidates for the request receiving terminal, the processor 24 specifies as the request receiving vehicle the parked vehicle parked at the position closest to the request sending vehicle among the parked vehicles associated with the terminals listed as candidates. Further, the processor 24 sets the terminal associated with that request receiving vehicle as the request receiving terminal.

At step 107, the processor 24 calculates the estimated time of arrival when the request sending vehicle will arrive at the parked position of the request receiving vehicle based on the parked position of the request receiving vehicle included in the yield possible signal returned from the request receiving terminal, the current position of the request sending vehicle included in the request signal, and map information stored in the storage device 22.

At step S108, the processor 24 sends a request signal requesting yielding of the parking space before the estimated time of arrival through the communication interface 21 and the communication network 5 to the request receiving terminal.

At step S109, the processor 24 judges whether it has received an accept signal from the request receiving terminal to the effect of being willing to yield the parking space within a certain time frame from when receiving the request signal. When receiving a decline signal from the request receiving terminal to the effect of not yielding the parking space or when there is no reply from the request receiving terminal in a certain time frame, the processor 24 proceeds to the processing of step S110. On the other hand, when receiving an accept signal, the processor 24 proceeds to the processing of step S111.

At step S110, the processor 24 deletes the request receiving terminal determined at step S106 from the candidates for the request receiving terminal, then returns to the processing of step S104.

At step S111, the processor 24 reads the parked position of the request receiving vehicle from the storage device 22 and sends a request succeed signal including that parked position through the communication interface 21 and the communication network 5 to the request sending terminal.

At step S112, if receiving a movement completion signal through the communication network 5 and communication interface 21 from the request receiving terminal, the processor 24 reads the points of the user of the request receiving terminal and the user corresponding to the request sending terminal from the storage device 22 and updates the read points.

Specifically, the processor 24 subtracts from the points held by the user corresponding to the request sending terminal the points corresponding to the total of the amount of consideration for getting a parking space yielded and a handling fee to update the points of the user of the request sending terminal and stores the updated points in the storage device 22. Further, the processor 24 adds to the points of the user corresponding to the request receiving terminal the amount of consideration for yielding the parking space to update the points of the user of the request receiving terminal and stores the updated points in the storage device 22.

The server 2 (parking space guidance apparatus) according to the present embodiment explained above comprises a communication interface 21 (communication part) able to communicate with the plurality of terminals 3-1 to 3-n associated with different vehicles 4-1 to 4-n, a storage device 22 (storage part) storing information expressing economic value held by the users of the plurality of terminals 3-1 to 3-n or the vehicles 4-1 to 4-n associated with the plurality of terminals 3-1 to 3-n and positions of parking spaces when the vehicles 4-1 to 4-n associated with the plurality of terminals 3-1 to 3-n park at parking spaces, and a processor 24 (control part) performing processing for guidance to a parking space.

Further, the processor 24 is configured so that when it receives from one terminal among the plurality of terminals 3-1 to 3-n a request signal seeking guidance to a parking space, it determines a request receiving terminal from which to request yielding of the parking space among the other terminals associated with the parked vehicles among the plurality of terminals 3-1 to 3-n and sends the request receiving terminal a request signal requesting yielding of the parking space. Further, the processor 24 is configured so that when receiving an accept signal from the request receiving terminal notifying willingness to yield its parking space, the processor 24 sends to the one terminal a request succeed signal including the position of the parking space which the request receiving vehicle associated with the request receiving terminal occupies. Further, the processor 24 is configured so that when receiving a movement completion signal notifying the parking at the parking space which the request receiving vehicle had been occupying has become possible, it decreases the economic value held by the user of the one terminal or the request sending vehicle and increases the economic value held by the user of the request receiving terminal or the request receiving vehicle.

Due to this, it is possible to prompt a user of another terminal associated with a vehicle occupying a parking space to move from the occupied parking space based on a request from the user of the one terminal desiring guidance to a parking space conditional on payment of an economic consideration and to guide the user of the one terminal desiring guidance to a parking space on a priority basis to the parking space which the user of the other terminal had been occupying.

Further, the processor 24 according to the present embodiment is further configured so that, when receiving a request signal, it sends other terminals an inquiry signal inquiring whether they are able to yield their parking spaces and determines as the request receiving terminal the terminal associated with the vehicle positioned at the closest location to the destination of the request sending vehicle in the vehicles associated with terminals which return yield possible signals including yes notifications in response to the inquiry signal.

Due to this, it is possible to guide the user of one terminal desiring to be guided to a parking space to parking spaces in the order of proximity to the destination.

Further, the request signal which the processor 24 according to the present embodiment sends includes an estimated time of arrival at which the request sending vehicle will arrive at the parking space which the request receiving vehicle had been occupying. For this reason, the user of the other terminal can suitably judge whether to yield the parking space in accordance with his own situation.

Further, when receiving a request seeking guidance to a parking space from a request sending user desiring to use a parking space, the parking space guidance method according to the present embodiment requests movement from a parking space to another user occupying that parking space conditional on payment of an economic consideration and guides the request sending user to the parking space which the other user had been occupying when the request is confirmed. Further, the economic consideration is exchanged after the request succeeds and the other user has rendered the parking space which he had been occupying a state where parking is possible.

Due to this, it is possible to guide a request sending user desiring to use a parking space conditional on payment of an economic consideration to a parking space on a priority basis.

### Second Embodiment

Next, a parking space guidance system according to a second embodiment of the present disclosure will be explained. The parking space guidance system according to the present embodiment differs from the first embodiment on the point of updating the points when the request sending user requesting yielding of the parking space was actually able to park at the parking space which had been occupied by the request receiving user from which movement was requested. Below, this point of difference will be focused on in the explanation.

The parking space guidance system according to the above-mentioned first embodiment updated the points when the request receiving vehicle which was requested to yield the parking space moved from that parking space, that is, when the server 2 received a movement completion signal.

However, it is conceivable that after the request receiving vehicle requested to yield the parking space moves from the parking space and before the user requesting yielding of a parking space parks at that emptied parking space, another vehicle will end up parking at that emptied parking space. This being so, if updating the points when the request receiving vehicle requested to yield the parking space moves from that parking space like in the parking space guidance system according to the above-mentioned first embodiment, the request sending user requesting yielding of the parking space will end up paying the request receiving user an economic consideration despite not being able to get the parking space yielded from the request receiving user requested to yield the parking space.

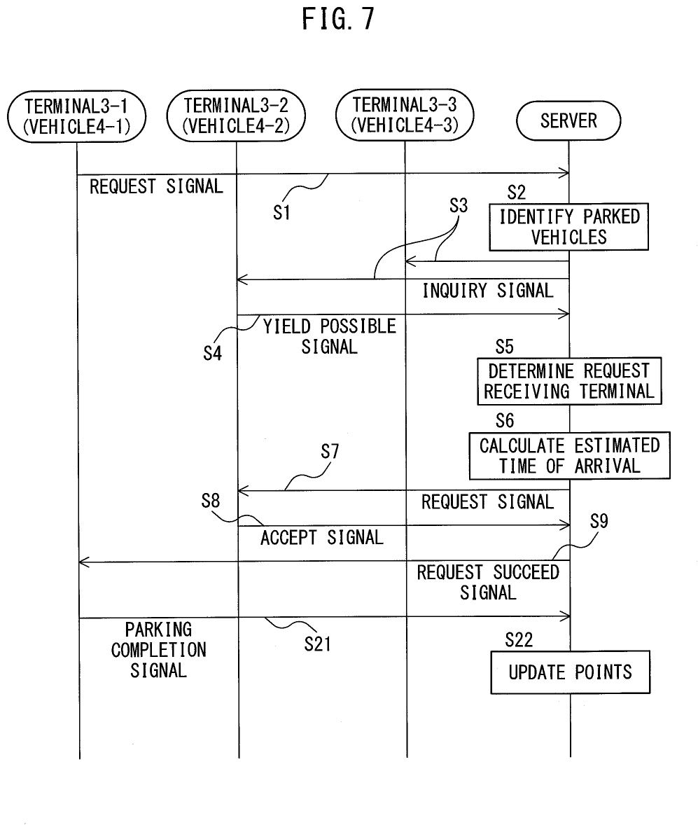

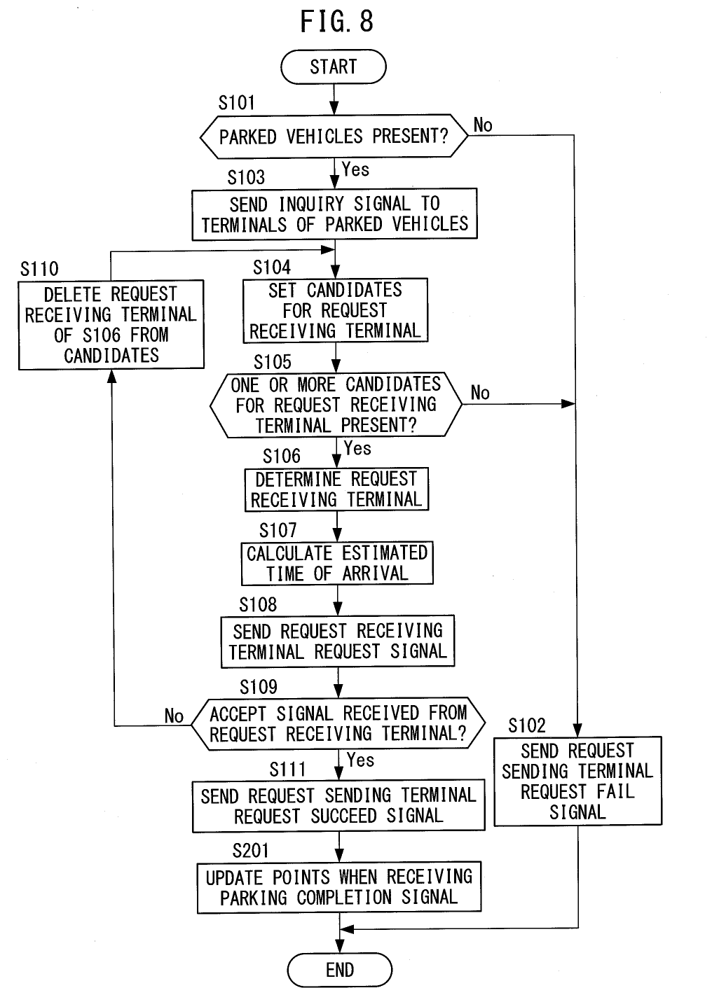

Therefore, the present embodiment is designed to update the points when the request sending user requesting yielding of the parking space was actually able to park at the parking space which the request receiving user requested to move had been occupying. Referring to FIG. 7 and FIG. 8, details of the processing for guidance to a parking space according to the present embodiment will be explained.

FIG. 7 is a view showing one example of a sequence of operations of processing for guidance to a parking space according to the present embodiment. It shows the flow of processing for guidance to a parking space in the case where, in the state shown in FIG. 4, the driver of the vehicle 4-1, that is, the user of the terminal 3-1 associated with the vehicle 4-1, desires to be guided to a parking space and the driver of the vehicle 4-2, that is, the user of the terminal 3-2 associated with the vehicle 4-2, has indicated his willingness to yield the parking space. Note that, at FIG. 7, step S1 to step S9 perform similar processing to the first embodiment, so here, the explanations will be omitted.

At step S21, the terminal 3-1 sends the server 2 a parking completion signal notifying the fact of completion of the vehicle 4-1 associated with the terminal 3-1 parking at the parking space 201 which the vehicle 4-2 associated with the terminal 3-2 had been occupying. The judgment of whether the vehicle 4-1 can park at the parking space 201 may be performed for example by judging the current position of the terminal 3-1 measured based on the received GPS signal as the position of the vehicle 4-1.

At step S22, when receiving a parking completion signal, the server 2 updates the points held by the user of the terminal 3-1 (request sending terminal) and the user of the terminal 3-2 (request receiving terminal). Specifically, the server 2 subtracts from the points held by the user of the terminal 3-1 the points corresponding to the total of the amount of consideration for getting a parking space yielded and a handling fee. Further, the server 2 adds to the points held by the user of the terminal 3-2 the amount of consideration for yielding the parking space.

FIG. 8 is a flow chart for explaining processing relating to the server 2 in processing for guidance to a parking space according to the present embodiment. When the server 2 receives a request signal, the processor 24 performs processing relating to the server 2 in the processing for guidance to a parking space in accordance with the present routine. Note that, in FIG. 8, step S101 to step S111 perform processing similar to the first embodiment, so here, explanations will be omitted.

At step S201, if receiving the parking completion signal from the request sending terminal through the communication network 5 and communication interface 21, the processor 24 reads the points of the user corresponding to the request receiving terminal and the user corresponding to the request sending terminal from the storage device 22 and updates the read points.

Specifically, in the same way as the first embodiment, the processor 24 subtracts from the points of the user corresponding to the request sending terminal the points corresponding to the total of the amount of consideration for getting the parking space yielded and the handling fee to update the points of the user of the request sending terminal and stores the updated points in the storage device 22. Further, the processor 24 adds to the points of the user corresponding to the request receiving terminal the amount of consideration for yielding the parking space to update the points of the user of the request receiving terminal and stores the updated points in the storage device 22.

The server 2 (parking space guidance apparatus) according to the present embodiment explained above, in the same way as the first embodiment, comprises a communication interface 21 (communication part), storage device 22 (storage part), and processor 24 (control part).

Further, the processor 24 is configured so as to decrease the economic value held by the user of the one terminal or the request sending vehicle and to increase the economic value held by the user of the request receiving terminal or the request receiving vehicle when receiving a parking completion signal notifying parking by the request sending vehicle associated with the one terminal in the parking space which had been occupied by the request receiving vehicle.

Further, in the parking space guidance method according to the present embodiment, the economic value is exchanged after the request for movement from the parking space succeeds and the parking space which the other user had been occupying is rendered a state enabling another user to park.

Due to this, an effect similar to the first embodiment is obtained. In addition, it is possible to keep economic value from being exchanged between the user of one terminal sending a request and a user of another terminal receiving the request regardless of not being able to be yielded the parking space from the user of the other terminal receiving the request.

Above, embodiments of the present disclosure were explained, but the above embodiments only show some of the examples of application of the present disclosure. It is not meant to limit the technical scope of the present disclosure to the specific constitutions of the embodiments.

1. A parking space guidance apparatus comprising:
a communication part able to communicate with a plurality of terminals associated with different vehicles;
a storage part storing information expressing economic value held by users of the plurality of terminals or vehicles associated with the plurality of terminals and positions of parking spaces when the vehicles associated with the plurality of terminals park at parking spaces; and
a control part performing processing for guidance to a parking space, wherein the control part is configured so that:
when receiving from one terminal among the plurality of terminals a request signal seeking guidance to a parking space, it determines a request receiving terminal from which to request yielding of a parking space from among other terminals associated with parked vehicles in the plurality of terminals and sends the request receiving terminal a request signal requesting yield of the parking space;
when receiving from the request receiving terminal an accept signal indicating willingness of yielding the parking space, sends to the one terminal a request succeed signal including the position of the parking space occupied by the request receiving vehicle associated with the request receiving terminal; and,
when receiving a movement completion signal indicating that parking at the parking space which the request receiving vehicle had been occupying has become possible or a parking completion signal indicating parking of the request sending vehicle associated with the one terminal at that parking space, decreases the economic value held by the user of the one terminal or the request sending vehicle and increases the economic value held by the user of the request receiving terminal or request receiving vehicle.

2. The parking space guidance apparatus according to claim 1, wherein
the control part is configured so that:
when receiving the request signal, it sends to the other terminals an inquiry signal inquiring whether they can yield their parking spaces; and
determines as the request receiving terminal the terminal associated with the vehicle positioned at the closest location to the destination of the request sending vehicle among the vehicles associated with terminals returning yield possible signals including yes notifications in response to the inquiry signal.

3. The parking space guidance apparatus according to claim 1, wherein
the request signal includes an estimated time of arrival at which the request sending vehicle will arrive at the parking space which the request receiving vehicle is occupying.

4. A parking space guidance method comprising:
receiving a request seeking guidance to a parking space from a request sending user desiring to use a parking space at which time it requests another user occupying a parking space to move from that parking space on the condition of being paid an economic consideration; and,
when that request is accepted, guiding the request sending user to the parking space which had been occupied by the other user.

5. The parking space guidance method according to claim 4 further comprising exchanging the economic consideration after the request is confirmed and the other user renders the parking space which the other user had been occupying a state enabling parking.

6. The parking space guidance method according to claim 4 further comprising exchanging the economic consideration after the request is confirmed and the parking space which the other user had been occupying is occupied by the request sending user.
